(19) United States
(12) Patent Application Publication
(10) Pub. No.: US 2024/0080286 A1
(43) Pub. Date: Mar. 7, 2024

(54) SYSTEMS AND METHODS FOR PROVIDING ADVANCED SMALL GROUP AND FAMILY UNIT DATA SHARING APPLICATIONS

(71) Applicant: Peter Robert KRAUS, Virginia Beach, VA (US)

(72) Inventor: Peter Robert KRAUS, Virginia Beach, VA (US)

(21) Appl. No.: 18/388,518

(22) Filed: Nov. 9, 2023

Related U.S. Application Data
(63) Continuation of application No. 18/101,609, filed on Jan. 26, 2023, now abandoned.
Application No. 18/101,609 is a continuation of application No. 16/267,366, filed on Feb. 4, 2019, now abandoned.
(60) Provisional application No. 62/626,192, filed on Feb. 5, 2018.

(51) Int. Cl. H04L 51/046; G06Q 30/0207; G06Q 50/00; H04L 9/40; H04L 65/611; H04L 65/75; H04L 67/104

(52) U.S. Cl. CPC H04L 51/046; G06Q 30/0239; G06Q 50/01; H04L 63/0407; H04L 65/611; H04L 65/762; H04L 67/1044

(57) ABSTRACT

The disclosed systems and methods provide organization, small group, and particularly family-oriented communications platforms, with computing device applications and services allowing users to post, store, organize and share transactions, events, stories, updates, conversations, photos, physical location information and videos and other small group shared, or family-related, information within specified small group units, including specified family units. A content-controlled data and information exchange environment, as a local unit network, is provided that effectively firewalls content providers from gaining insight into the information exchanged by, and preferences of, any individual member of the group, while maintaining transparency into the interests, goals, objectives and data exchange preferences of the group. These objectives are implemented via a specific communications gateway between the local group network and external communication nodes.

This application is a Continuation of U.S. patent application Ser. No. 18/101,609, entitled “Systems and Methods for Providing Advanced Small Group and Family Unit Data Sharing Applications,” by Peter Robert Kraus, filed in the U.S. Patent and Trademark Office (“USPTO”) on Jan. 26, 2023, which in turn is a Continuation of U.S. patent application Ser. No. 16/267,366, entitled “Systems and Methods for Providing Advanced Small Group and Family Unit Data Sharing Applications,” by Peter Robert Kraus, filed in the USPTO on Feb. 4, 2019, which in turn claims the benefit of U.S. Provisional Patent Application No. 62/626,102, entitled “Advanced Small Group and Family Unit Data Sharing Application,” by Peter Robert Kraus, filed in the USPTO on Feb. 4, 2018, the disclosures of which are hereby incorporated by reference herein in their entirety.

### BACKGROUND

### 1. Field of the Disclosed Embodiments

The disclosed embodiments provide small group, and particularly family-oriented communications platforms, with computing device applications and services allowing users to post, store, organize and share transactions, events, stories, updates, conversations, photos, videos, physical location and other small group shared, or family-related, information within specified small group units, including specified family units.

### 2. Related Art

The last several decades have seen a ubiquitous proliferation of personal electronic devices including, but not limited to, tablets, mobile communicating devices such as smart phones, and the increasing population of all manner of wearable devices. Many individuals carry multiple devices that “talk” to one another across common information sharing applications, and to further communicate with the individuals' desktop and/or laptop computers for data exchange, archiving, and general record keeping.

Portable electronic devices come loaded with all manner of communicating, information exchange, data sharing, and time management “tools” designed to simplify a particular individual user's life through social interaction, ready access to “necessary” information and an immediate archive for a person's life. Personal contacts lists, “to do” lists, calendars, notes, and reminders are maintained in the individual user's electronic device in an effort to organize, streamline, and/or optimize the individual user's life. Commonly-used links for access to news, entertainment, shopping, and items of interest for the particular user are also typically catalogued in a manner that further streamlines the individual user's “necessary” communication tasks.

Unfortunately, there is often little commonality or crosstalk between individual user applications without significant manual interaction by the user. To any extent that particular applications may be “linked,” those applications generally remain specific to the particular individual user and to her or his device(s). Data and information sharing, even among a small group of users, typically requires that significant manual interaction by each of the individual users in the group in order to provide any, even elementary, level of coordination for information sharing between the members of the small group.

Sophisticated project management software and project tracking applications do exist to facilitate group projects. These applications tend to be comparatively cumbersome, often requiring dedicated administrators and man-hours of manipulation in order to be effectively employed. In other words, the currently available suites of products do not easily lend themselves to personal and individual time and data management, and information sharing, among small specified groups of individuals.

Social networks are also becoming more prolific. Social networks are, of their nature, very public, so as to be social by design. All of the personal information regarding a particular user is posted, in some fashion, for all participants to see.

### SUMMARY OF THE DISCLOSED EMBODIMENTS

In view of the clear need, and easily identifiable shortfalls in currently available systems, it would be advantageous to provide a data management system particularly tailored to information sharing among small, specified groups of individuals, including, but not limited to, family groups/units. Put another way, as life is increasingly experienced and represented in a digital form on myriad personal computing and communicating systems, individual members of small groups may be aided in small group information sharing by advantageously tailoring or adapting features of business processes and technologic advantages achievable through cumbersome business platforms to better serve family units and small “family-like” groups.

Exemplary embodiments of the systems, methods, processes, schemes, techniques and/or applications according to this disclosure may tailor particular combinations of application features in a unique manner, protected by improved, yet streamlined, encrypting and encoding schemes, to deliver a new small-group (family) centric user experience with business and technology processes improving all aspects of individual data exchange among users and select interactions with commerce platforms—from advertising and marketing communications, through payment and settlement, to affinity programs.

Exemplary embodiments may make advantageous use of portions of conventional business-to-business (B2B) and business-to-consumer (B2C) and even business-to-business-to-consumer (B2B2C) enterprise models to particularly tailor and provide what may be considered a business-to-family (B2F) enterprise solution. Data exchange may be specifically tailored to the specific needs of small organizations, small groups, or in particular family units in order that intra-group data exchange may occur in a secure and controlled environment while providing specified access to particular external links in order to facilitate exchange with conventional content providers.

Exemplary embodiments may emplace a particular enterprise solution between the electronic devices employed by members of a particular small group. The enterprise solution may host particular rules established by the members of the particular group as implemented by a group administrator thus expanding the capacity of individuals in the group to share data in a peer-to-peer collaborative intra-group data exchange environment.

Exemplary embodiments may address the drawback of overly broad personal information sharing that exists in social networking and according to the social network platforms. The disclosed private networks are at an opposite end of the spectrum with regard to private information sharing among a general population of users.

In embodiments, the enterprise solution may limit access to particular content external to the group communications according to the particular rules established by the members of the group as implemented by the group administrator. This may represent a key differentiator between the disclosed schemes and social networks, even those social networks creating groups. The content algorithms in in the disclosed embodiments may be controlled by a local group administrator rather than a centralized network operator.

Exemplary embodiments may provide a user-friendly immersive display environment in which particular data communications between members of the group may be represented as intra-group channels for data exchange.

In embodiments, a scheme may be implemented by which individual users are incentivized to participate in the data exchange between participants, and in additional data sharing and exchange evolutions. Such incentivisation schemes may provide individual users with tokens as rewards for participation. Such tokens may be accumulated for use in a barter-type exchange scheme in order to provide further incentives for active participation and communication within the small group.

These and other features, and advantages, of the disclosed systems, methods, applications and devices are described in, or apparent from, the following detailed description of various exemplary embodiments.

### BRIEF DESCRIPTION OF THE DRAWINGS

Various exemplary embodiments of the disclosed systems and methods for providing small group, and particularly family-oriented communications platforms, with computing device applications and services allowing users to post, store, organize and share transactions, events, stories, updates, conversations, photos, videos and other small group shared, or family-related, information within specified small group units, including specified family units, according to this disclosure, will be described, in detail, with reference to the following drawings, in which:

FIG. 1 schematically illustrates a simple block diagram of the manner in which the disclosed schemes represent an improvement over conventional business-to-business and business-to-consumer systems;

FIG. 2 illustrates a block diagram of an exemplary system for implementing a secure and content-controlled data exchange scheme according to this disclosure;

FIG. 3 illustrates a block diagram of certain additional details of the exemplary system for implementing a secure and content-controlled data exchange scheme according to this disclosure;

FIG. 4 illustrates a block diagram of further additional details of the exemplary system for implementing a secure and content-controlled data exchange scheme according to this disclosure;

FIG. 5 illustrates a block diagram of a variation of the exemplary system for implementing a secure and content-controlled data exchange scheme according to this disclosure; and

FIG. 6 illustrates a flowchart of an exemplary method for implementing an automated, and potentially artificially intelligent, scheme for secure and content-controlled data exchange, particularly among members of a small group, according to this disclosure.

### DETAILED DESCRIPTION OF EMBODIMENTS

The disclosed advanced communication and information sharing systems and methods may provide unique configurations for implementing schemes, processes, techniques and the like for optimizing all manner of data exchange among participating (and enrolled) members of a particular small group. Significant amounts of data currently flowing through B2C enterprise experiences may be shifted and better handled as a targeted and/or specified business-to-organization (B2O) (or business-to-small group—B2SG or nosiness-to-family—B2F) enterprise solution, which may be particularly optimized for consumers within small groups and family/extended family units. Although particularly directed to such a B2F enterprise solution targeted for small groups and family units, those of skill in the art will appreciate that many different organization and/or small-group enterprises may benefit from the advantages of incorporating within their individual users' mobile computing and communicating platforms, a targeted B2O/B2SG/B2F enterprise solution including varying combinations of the features according to the disclosed embodiments.

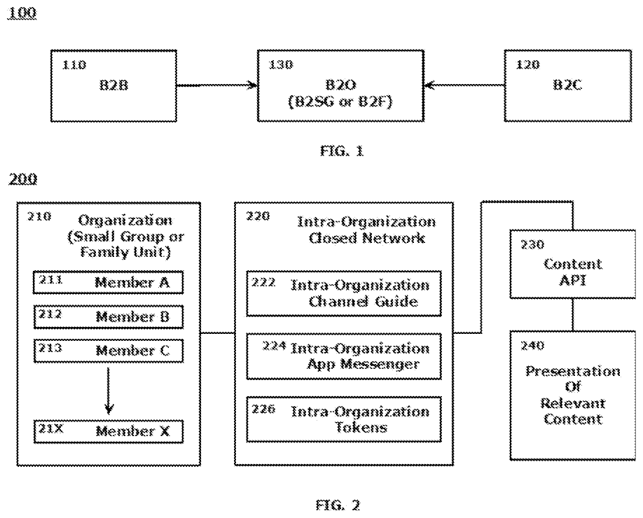

FIG. 1 schematically illustrates a simple block diagram 100 of the manner in which the disclosed schemes may represent an improvement over conventional business-to-business (B2B) and business-to-consumer (B2C) systems. In embodiments, conventional B2B enterprises 110 and B2C enterprise models 120 may service the disclosed B2O/B2SG/B2F enterprise solution 130 substantially as indicated.

With this new model, organization, small group and family members may connect and form closed, secure mini-networks over which they may share digital content with each other. Then, they may connect their respective mini-networks with other service provider networks via secure channels delivering relevant services based on a cognitive computing service, which each organization, small group or family may program or tailor the enterprise to its own use.

An advantage of configurations according to this disclosure has to do with further enabling members of small groups, including but not limited to family members in family units, to engage in secure multi-threaded, multi-media conversations with each other, and with third party content/service providers, including via what may be described as branded “family channels.” The conversations and data exchanges may be undertaken in a secure communicating environment in a manner that significantly improves trust in the security of shared data, and delivers compelling targeted new B2F customer experiences. Collectively, the specified channels may run on a particularly-segregated and secure network in which, for example, a household user group, rather than the individual user, may constitute the principal originating node in the network system, and in which transactions may be based on the family's defined collective interests and values.

An objective advantage of the disclosed secure B2F enterprise solution is that the intelligence engine is based on a starting point of a secure enterprise computing-like model with a target of applying its enterprise benefits to small group collective interests and communicating schemes rather than to those of individual users. Embodiments of the disclosed B2F enterprise solution may assimilate the communicating methodologies of each of the group members to present to the group a modifiable laydown of communication nodes specifically attuned to the small group dynamic. In a case of families as the small groups, the disclosed B2F enterprise solution may select and engage resource providers that want to connect with consumers in the context of family units. This approach is differentiable from conventional consumer messaging methods having their origins in individual peer-to-peer (P2P) networking, which profile individual consumers rather than considering the context of grouped users. The conventional methods treat individual users as each a separate and distinct communicating entity and build a scheme of communication around individual user habits and preferences. The conventional methods are generally not adaptive enough to reasonably support the small group communication schemes according to the disclosed embodiments. The conventional schemes access personal identification information (PII) for the users and their uses to build extensive user profiles according to generally requested and permitted collection schemes for the PII. In conventional schemes, the individual users, rather than the engine itself, voluntarily define their relationships with other individual users on the network. Service and content providers are generally challenged to understand intra-group dynamics, including family ties. In the case of families, this challenge may manifest itself in a requirement, for example, for a parent, guardian or authorized caregiver, to manually, and in a comparatively cumbersome manner, build out their own relational models to ensure compliance with a desired communicating scheme. It is cumbersome for the service providers to build out a relational model, particularly as data privacy laws expand. In embodiments of the disclosed secure B2F enterprise solution, third party providers do not need to store personal identification information and individual group member interconnections. These providers may serve up the data/information conduit, while relationships and identities of individual members remain encrypted on the platform within the mini-network.

FIG. 2 illustrates a block diagram 200 of an exemplary system for implementing a secure and content-controlled data exchange scheme according to this disclosure. According to embodiments of the disclosed schemes, each organization, small group, or family, collective node 210 may serve as a configurable personalized mini-framework to protect and support its individual organization, small group or family members (Member A 211, Member B 212, Member C 213, through Member X 21X). The number of members serviceable by the enterprise may be open-ended in order to accommodate all of the intra-organization and/or intra-family data exchange and communication dynamics. In this regard, substantially all intra-group communications, e.g., all private messages, calendar entries and indications of physical location of users within the family, may be serviced according to an intra-organization closed network communications capability 220 which may include, for example, an intra-organization channel guide 222, an intra-organization application (app) messenger 224 and a capacity for collecting and cataloging intra-organization tokens 226 as indicators of individual member use of the close network. The private messages within the family unit then, for example, remain encrypted, segregated and/or not “visible” to third parties, including outside marketers, malevolent actors and content/service providers that the organization, small group or family unit may selectively have not engaged, or chosen to restrict. Meanwhile, cognitive computing and machine learning securely deployed within each node may remain able to identify the organization's (small group's or family's) unique shared values and interests through, for example, some manner of content Application Program Interface (API) 230, and efficiently calibrate connections between the organization, small group or family unit and pre-selected, pre-screened and/or “screened-on-the-fly” third party content providers for the presentation of relevant content 240, i.e., acceptable content according to the dynamics of the family unit, and a set of rules established to maintain distance from unwanted outside influences. The disclosed B2F enterprise solution may thus enable a scalable commercial framework to serve small groups with an objective of particularly supporting family units, or households, with dependents in the manner generally outlined in FIG. 2.

With reference generally to the depiction in FIG. 2 as an overview, configurations of the disclosed B2F enterprise solution may incorporate a plurality of interrelated processes or enterprise components designed, in use, to bring a new customer experience to market particularly attuned to maintain highest security as to intra-group communications and data sharing, while keeping a firewall to the world, with accessibility to only select content providers.

Examples of such processes or enterprise components may be as listed below. It should be noted that this list is not intended to be exhaustive, but rather exemplary in nature with regard to included or includable enterprise solution components.

First, a secure network, which may be specifically permissioned, and decentralized, may be provided to connect individuals within the small group and to segregate them even according to an internal group classification scheme. When dealing with family units, for example, the disclosed B2F enterprise solution may be designed to connect all generations in the family, or family-like groups, with each other and with trusted service providers, including commercial and philanthropic service providers and the like.

Second, a mobile platform application may provide mobile and web interfaces specifically designed to drive participation by all members of the group according to their wants and desires, including, for example, multiple generations of consumers in a family unit.

Third, access to a restricted set of external channels (considered “Family Channels”) may be provided according to a configurable, customizable, multi-threaded communication scheme for securely protecting communications from a small group, and any member thereof, with the channels. These channels may facilitate communication between small groups and/or any combination of small group members (family members) and content providers with APIs for content and machine conversations (BOTs), and graphical interfaces to design, deploy and manage channels, and channel interaction in a simple user-friendly manner.

Fourth, a programmable rules engine may be provided in a form of a group guide or family guide, for example, associated with each group or family on the network processing of inputs from cognitive computing services, direct group/family input and templates.

Fifth, a loyalty “currency” (consider Family Token) may be established, including through cryptography, that may be usable for recognizing and rewarding group/family members who complete defined tasks and goals together, and enabling group/family leaders (including in a family context, for example, parents and grandparents) to reward positive behavior within their group and/or family units/networks, and via connected commercial and philanthropic service providers to reward engagement.

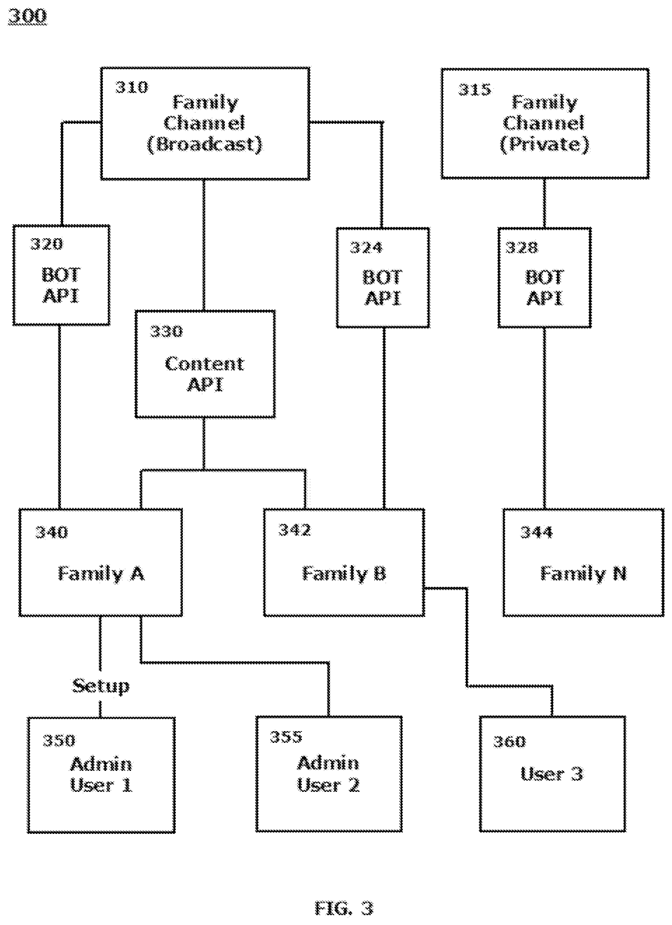

FIG. 3 illustrates a block diagram 300 of certain additional details of the exemplary system for implementing a secure and content-controlled data exchange scheme according to this disclosure. Embodiments of the disclosed B2F enterprise solution may provide a scheme whereby, rather than existing as individuals in the digital universe, members within small group collectives of individuals, including families, are served as one unit, set up and administered by a group/family leader (serving roles such as parent, guardian or caregiver) typically carrying legal and compliance obligations at least as an admin user 1 350 for set up, or an admin user 2 355 for execution of the enterprise for one or more family units (family A 340, family B 342, through family N 344). In embodiments, the disclosed B2F enterprise solution may deliver a superior and differentiated user/customer experience when compared to conventional social networks and particularly to anonymous and “permission-less” P2P network exchanges. The disclosed enterprise schemes also differ from conventional enterprise computing models requiring different legal frameworks and systems requirements.

Exemplary embodiments of the disclosed B2F enterprise solution may provide a capacity by which (a) organizations, small groups and families, and (b) content providers, may connect in several ways depending on individual disclosure and security requirements. Private BOT processes may be, for example, run with any combination of organization, small group or family members in a threaded conversation by content providers through a BOT API 320,324,328. Content providers may publish content in a broadcast style, as for example, a family channel (broadcast) 310, available for any small or family group on the network through a Content API 330. Semantic text analysis and image machine learning may be applied to ensure content served by content providers meets standards (or rules) set for the organization come small group or family communication, including but not limited to placing commercial advertising messages in local channels that is relevant to the channel content and group or family unit preferences defined through cognitive computing of anonymized data within the unit. Private networks, such as, for example, family channel (private) 315, may occur when these communication channels are available by designation or invitation only, and may be made available to multiple families participating on the same communication channel, and ultimately to each end-user 360. Private networking administration tools may be provided to channel owners, such as to communicate with groupings of groups or families.

The disclosed network-based B2F enterprise solution may be accessed by consumers via a native device and web applications, which may be collectively branded. This enable consumers to create their small group or family network and engage with channels as described above and to engage in encrypted conversation threads, including, e.g., end-to-end (E2E) 256-bit encrypted conversation threads, with any selected combinations of group/family members and/or channels. The secure encryption technology offers additional protection from unwanted sharing of, or access to, information, including personal information and data content of any of the small group or family members. The disclosed enterprise solutions may allow connected content and/or service providers to serve the small groups and families as units, but prevent the connected content and/or service providers from seeing competing channel content or communication within the groups, or direct family threads—intra-group or intra-family communications. This scheme helps to promote small group and family sharing, since members can securely share content including photos, videos, physical location information and live streaming with specific small group or family members, and continue to own the data shared within the group/family. It also enables group and family administrators to control access to the unit by third parties and to prohibit the disclosure of information beyond what is explicitly shared through the connected channel and consented to by the appropriate group or family member. In addition to messaging, the application supporting the disclosed B2F enterprise solutions may include other useful group-supported capabilities. These may include, for example, a shared event feed and calendar where group/family members may record activities or find activities available from channels during certain times. Physical locations of individual users may be shared among group members via the application. The application may also include a rewards account storing tokens, which may be allocated to group/family members for spending on the network.

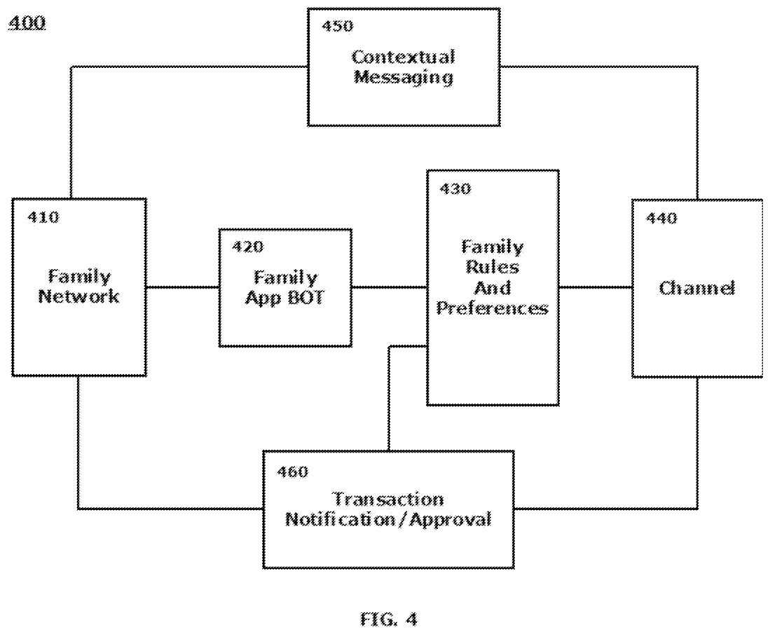

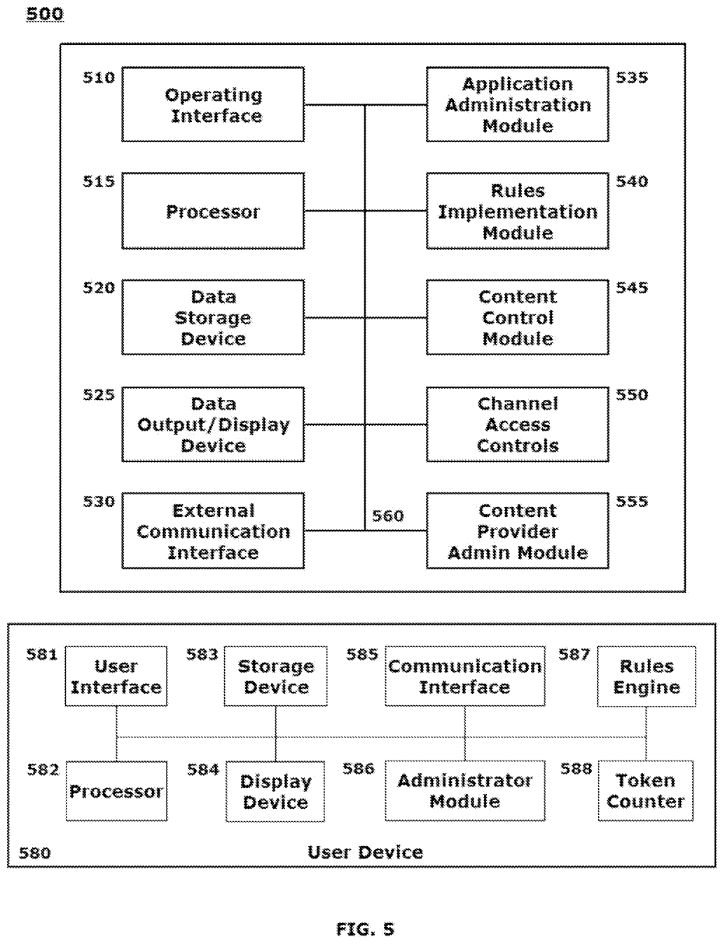

FIG. 4 illustrates a block diagram 400 of further additional details of the exemplary system for implementing a secure and content-controlled data exchange scheme according to this disclosure. As shown in FIG. 4, small groups or families may be provided a process by which to program a rules engine according to family rules and preferences 430 with the assistance of cognitive computing designed to help bring the group/family together and focus on the “right” information, according to the group/family. Such an engine may be supported by a family app BOT 420 of certain content from a channel 440 internally to the family network 410 in instances where engagement may assimilate and employ a combination of inputs from group/family network usage to control contextual messaging 450 and transaction notification/approval for 60 as between the channel 440 and the family network 410. The available/usable inputs from the group/family network may include, but not be limited to:
a. Interacting with the stored family app BOT 429 to set preferences, add events, and the like;
b. Adding/removing channels with rule templates generated, stored and/or updated as the family rules and preferences 430 to their group/family guide;
c. Semantic analysis of the family messaging (contextual messaging 450) recorded by the application and/or the network hosting the disclosed B2F enterprise solution;
d. Machine learning of group/family network content to determine group/family preferences; and
e. Approval/rejection of payment and event type transaction requests, via transaction notification/approval 460 made by group/family members or admins.

Group/family rules and preferences may then be made available to connected content and/or service providers so those providers may deliver contextual content calibrated with the groups' and/or families' interests, thereby increasing engagement and conversion. Furthermore, content/service providers may use the group/family guide to ensure compliance with regulations related to admin, parent or guardian notification and/or approval.

With the network configuration and rules engine described above, the disclose B2F enterprise solutions may have all the components necessary for groups/families and content/service providers to reward group/family members for engagement in positive activities and causes. Content/service providers can reward groups/families for their collective behavior based on any combined measurement of variables tied to marketing and loyalty campaigns, including, but not limited to:
Group/family attention—the time spent by group/family members on a defined object;
Group/family togetherness—the number of group/family members participating in a defined object/activity;
Group/family transactions—a purchase (or referral) by group/family members of a defined object, content or service provider; and/or
Group/family mass—the participation level of a group family in the network. This function may be programmed by the disclosed enterprise solution rather than content/service providers and/or the groups/families themselves.

These “Proof-of-Group” or “Proof-of-Family” examples may include having a group/family dinner, going to an activity outside the group/house together, chipping in together for a charitable project donation, or even chatting with others (grandparents) who live across the country. Rewards for these proofs can also be coupled, stacked or multiplied, for example, in a family context, a family dinner (“family togetherness”) out at a restaurant that has provided a special family offer (“family transactions”).

The deployment process may start by funding a group/family account with group/family tokens. This may be done a variety of ways, including: groups/families purchasing tokens; providers rewarding loyalty by depositing tokens in a group/family account and the enterprise solution itself depositing tokens as a marketing promotion. Then, group/family admins may set rules for distribution of tokens to group/family member individual accounts. Distribution rules may reflect the specific values and traditions of a group, particularly a family unit, or can be applied as a template, for example, some groups/families provide a weekly allowance; whereas, other families provide a stipend based on performance of certain tasks.

The exchange rate between a “Family Token” and a given group's/family's fiat currency, as well as token redemption opportunities, may be set by the group/family network or connected provider network participating in the exchange. Family Tokens may not be designed to replace sovereign currencies or store large values, but rather to provide an internal measured incentive for group/family and/or content/service provider network participation, and to facilitate the recording of transactions of defined value across a decentralized ledger. One go-to-market strategy may contemplate launching the rewards program after deploying several content/service providers with content, which sets the token valuation.

FIG. 5 illustrates a block diagram 500 of a variation of the exemplary system for implementing a secure and content-controlled data exchange scheme according to this disclosure.

The exemplary system 500 may include an operating interface 510 by which a user as a host may communicate with the exemplary system 500. The operating interface 510 may provide a host an opportunity initiate the backend process to support the information exchange with myriad individual family networks and family network user devices 580. Additionally, the operating interface 510 may provide the host and capacity to input any parameters appropriate to oversight of the system in engaging individual small group networks and overseeing the rules and preferences defined by each of the individual small group networks. The operating interface 510 may be configured as one or more conventional mechanisms common to computing and/or communication devices that may permit the host to input information to the exemplary system. The operating interface 510 may include, for example, a conventional keyboard, a touchscreen with “soft” buttons or with various components for use with a compatible stylus, a microphone by which the host may provide oral commands to the exemplary system to be “translated” by a voice recognition program, or other like device by which a user may communicate specific operating instructions to the exemplary system.

The exemplary system may include one or more local processors 515 for individually operating the exemplary system and for carrying into effect the disclosed schemes, for implementing the BOTs and/or the APIs in the exemplary system in the matter generally described above. The processor 215 may carry out routines appropriate to operation of the exemplary system, and may undertake data manipulation and analysis functions appropriate to the interface established between multiple organization, small group or family unit networks and the various content providers in the matter generally depicted above. Processor(s) 515 may include at least one conventional processor or microprocessor that interprets and executes instructions to direct specific functioning of the exemplary system, and control of the automated implementations of secure network integration according to this disclosure.

The exemplary system may include one or more data storage devices 520. Such data storage device(s) 520 may be used to store data or operating programs to be used by the exemplary system, and specifically the processor(s) 515 in carrying into effect the various participant organization, small group or family unit interacting parameters, and token rewards schemes and notification functions. At least one of the data storage device(s) 520 may be used to store the various sets of small network rules and preferences in order to carry into effect the collaborative communication exchange according to this disclosure. At least one of the data storage device(s) 520 may be used to store particular identification information that may be collected incumbent to individual small group networks participating in the secure, content-controlled data exchange scheme. The data storage device(s) 520 may include a random access memory (RAM) or another type of dynamic storage device that is capable of storing updatable database information, and for separately storing instructions for execution of system operations by, for example, processor(s) 515. Data storage device(s) 520 may also include a read-only memory (ROM), which may include a conventional ROM device or another type of static storage device that stores static information and instructions for processor(s) 515. Further, the data storage device(s) 520 may be integral to the exemplary system, or may be provided external to, and in wired or wireless communication with, the exemplary system, including as cloud-based (or other virtual) data storage components.

The exemplary system may include at least one data output/display device 525, which may be configured as one or more conventional mechanisms that output information to a user, in this case a host on a process and/or progress of interaction control via this communication gateway. The data output/display device 525 may be used to indicate to the host information regarding a compilation of individual group users' preferences and/or rules for content exchange via the communication gateway. It is not necessary that the host monitor the actual conduct of the operation by the exemplary system, but the host is afforded that option.

The exemplary system may include one or more separate external communication interfaces 530 by which the exemplary system may execute its function as a communication gateway to communicate between individual organization, small group or family unit networks, via one or more user devices 580, and external content providers in the matter described above, typically in wireless communication with the exemplary system.

The exemplary system may include an application administration module 535 that may be used to receive and store participant registration, identification and/or rule/preference information for individual participating organization, small group or family unit networks seeking to engage content providers via the exemplary system. The application administration module 535 may be a component or capability of one or more of the processors 515, or may be made available as a standalone capability.

The exemplary system may include one or more of a rules implementation module 540, a content control module 545, channel access controls 550, and/or a content provider admin module 555 (including a channel content provider admin module), by which individual data exchange functions and controls may be implemented by the exemplary system in a manner consistent with the above descriptions. Each of the specific capabilities may be highlighted as a standalone system, or may be incorporated as a component or capability of one or more of the processors 550. Separately, one or more of these enumerated functions may be carried into effect by one or more BOTs or APIs undertaking the particularly-indicated functions of the exemplary system. For example, the token distribution/engagement reward functions may be carried into effect by one or more of the application administration module 535, rules implementation module 540, and/or by one or more of the processors 515.

Each of the individual functions, modules, devices and/or units of the exemplary system may be varyingly interconnected by one or more data exchange and control buses 560. Such data exchange and control buses 560 may take the form of wired or wireless communications interfaces between the various enumerated components.

The exemplary system may communicate with one or more individual user devices 580, each of which may include a user interface 581, processor 582, storage device 583, display device 584, communication interface 585, administrator module 586, rules engine 587 and token counter 588. The user as a participant in a secure, content-controlled local network within an organization, small group or family unit may employ the user device 580 for interaction with the exemplary system as it carries into effect the disclosed schemes for implementing communication gateway between individual small group or family unit networks and content providers. It should be noted that one or more of the user devices 580 may implement or restrict local administration according to preferences established by the local network administrator. It is envisioned that the user device 580 may include any one or more of currently typically employed handheld devices including mobile communicating devices, mobile phones, mobile smart phones, mobile tablets and the like. The definition of the user device 580 as envisioned by the enclosed schemes is not, however, limited to such handheld devices. Rather, user devices 580 as contemplated by this disclosure include any devices which may be usable for content delivery from content/service providers to individual users and a local organization, small group or family unit network. These may include, for example, user-wearable devices such as, for example, wearable computer/communicating display glasses and/or watches, biometric sensors, virtual reality (or immersion) devices including goggles, helmets, tactile gloves and the like, and other known or developed wearable components for carrying out one or more of computing and/or communicating functions allowing user to communicate with the exemplary system.

As noted above, all of the various components of the exemplary system, as depicted in FIG. 5, may be connected internally, and to one or more external components by one or more data/control busses 560. These data/control busses 560 may provide wired or wireless communication between the various components of the exemplary system, whether all of the components of the exemplary system are housed integrally in, or are otherwise external and connected to, the exemplary system.

It should be appreciated further that, although depicted in FIG. 5 as an essentially integral unit, the various disclosed elements of the exemplary system may be arranged in any combination of sub-systems as individual components or combinations of components, integral to a single unit, or external to, and in wired or wireless communication with the single unit of the exemplary system. Wireless communications may be by RF radio devices, optical interfaces, NFC devices and other wireless communicating devices according to RF, Wi-Fi, WiGig and other like communications protocols. In other words, no specific configuration as an integral unit, or as a support unit, is to be implied by the depiction in FIG. 5. Further, although depicted as individual units for ease of understanding of the details provided in this disclosure regarding the exemplary interface and control system, it should be understood that the described functions of any of the individually-depicted components may be undertaken, for example, by one or more processors 515 connected to, and in communication with, one or more data storage device(s) 520.

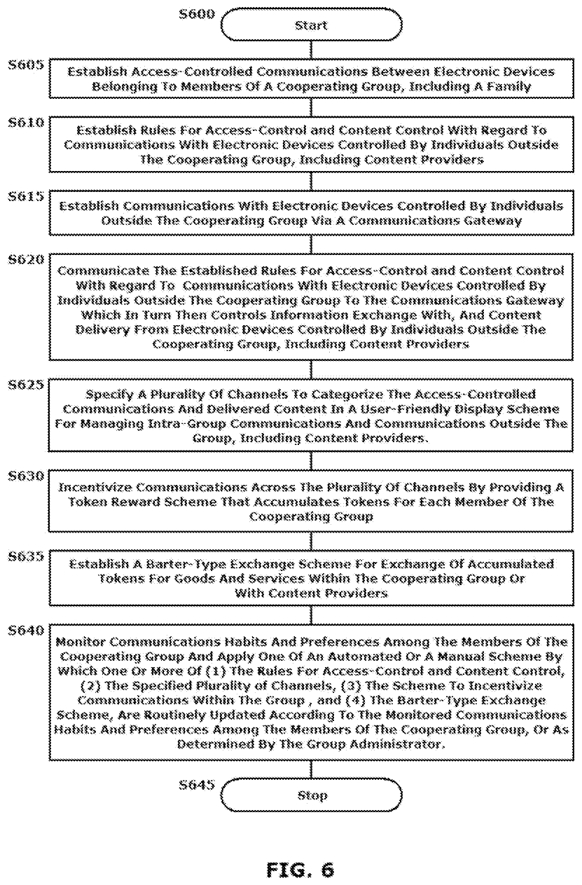

FIG. 6 illustrates a flowchart of an exemplary method for implementing an automated, and potentially artificially intelligent, scheme for secure and content-controlled data exchange, particularly among members of a small group, according to this disclosure. As shown in FIG. 6, operation of the method commences at Step S600 and proceeds to Step S605.

In Step S605, communication may be established according to certain access controls between electronic devices belonging to members of a cooperating group, including a family unit. Operation of the method proceeds to Step S610.

In Step S610, rules for at least one of access control and content control may be established with regard to communications with electronic devices controlled by individuals outside the cooperating group. Such individuals may include other business or social contacts, content providers, service providers and the like. Operation of the method proceeds to Step S615.

In Step S615, communications may be established with electronic devices controlled by individuals outside the cooperative group (such as those enumerated briefly above) via a communications gateway. The communications gateway may be in the form of the disclosed system described in detail above. Operation of the method proceeds to Step S620.

In Step S620, the established rules for access control and/or content control with regard to communications with electronic devices controlled by individuals outside the cooperating group may be communicated to the communications gateway for implementation. Such implementation may include, but not be limited to, controlling information exchange with, and content delivery from, electronic devices controlled by individuals outside the cooperating group. In this manner, individual identities and preferences of members of the cooperating group may be masked to the outside individuals. The communications gateway may establish protocols by which the outside individuals may gain certain insight into the group dynamic but not into the identities or preferences of any particular individual within the group. Operation of the method proceeds to Step S625.

In Step S625, one or more of a plurality of communication channels may be specified to categorize the access-controlled communications between, and/or delivered content to, individual users within a particular cooperating group in a manner that provides a user-friendly display scheme particularly focused at managing intra-group communications and communications outside the group as separate entities. It is envisioned that such a display will be supplemented with indications as to individual group member's participation in intra-group exchanges and an indication further of any incentives (tokens or rewards) that may accrue for such individual group member's participations. Operation of the method proceeds to Step S630.

In Step S630, an internal program to incentivize individual group member's participation in intra-group communication and/or data exchange may be established across the plurality of channels by providing, for example, a token reward scheme that accumulates tokens for each individual group member's participations. Operation of the method proceeds to Step S635.

In Step S635, some form of barter-type exchange scheme may be established for exchange of accumulated tokens for goods and services within the cooperating group and/or with content providers. Any established barter-type exchange scheme may be under the exclusive control of the group network administrator in order to ensure that particular objectives of the organization, small group or family unit are incentivized while other influences, particularly those which may run counter to the objectives of the organization, small group for family unit are minimized. Operation of the method proceeds to Step S640.

In Step S640, it is envisioned that according to the above steps, a recursive scheme of intra-group interaction will be stimulated as individual group members are comfortable to share communications, information and/or data in a protected environment. Routine monitoring of the communications habits and preferences among the members of the cooperating group may be undertaken such that one or more of an automated scheme or a manual update-type scheme may be implemented to modify, according to use, one or more of: (1) the rules for access-control and content control among the users of the local network; (2) additions to, deletions from, or other modifications for the specified plurality of channels available to individual users of the local network; (3) the scheme to incentivize communications within the group according to, for example, the award of tokens for certain particular acts; and/or (4) the barter-type exchange system by which accumulated tokens are “cashed in.” All internal changes to the rules and preferences of the group may be proposed to the group administrator for approval. These monitoring and update functions are envisioned to ensure certain dynamic feedback within the organization, small group or family unit network in order that the needs of the individual users are met without disturbing the overall objectives of the organization, small group or family unit in maintaining some control over access to their internal communications and exchange with individuals and/or entities external to the group. Operation the method proceeds to Step S645, where operation of the method ceases.

The disclosed embodiments may include a non-transitory computer-readable medium storing instructions which, when executed by a processor may cause the processor to execute all, or at least some, of the steps of the method outlined above.

Although depicted in a particular sequence, it should be noted that the steps of the method are not limited to the order shown. The steps of the exemplary disclosed method may be, for example, executed in any manner limited only where the execution of any particular method step provides a necessary precondition to the execution of any other method step.

Although the above description may contain specific details as to one or more of the overall objectives of the disclosed schemes, and exemplary overviews of systems and methods for carrying into effect those objectives, these details should be considered as illustrative only, and not construed as limiting the disclosure in any way. Other configurations of the described embodiments may properly consider to be part of the scope of the disclosed embodiments. For example, the principles of the disclosed embodiments may be applied to each individual user group where each user group may individually access features of the disclosed B2O/B2SG/B2F enterprise solution, as needed, according to one or more of the multiply discussed configurations. This enables each user to make full use of the benefits of the disclosed embodiments even if any one of a large number of possible applications do not need all of the described functionality. In other words, there may be multiple instances of the disclosed systems, methods and devices each being separately employed in various possible ways at the same time where the actions of one user do not necessarily affect the actions of other users using separate and discrete embodiments.

Other configurations of the described embodiments of the disclosed systems and methods are, therefore, part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A non-transitory computer readable medium containing program instructions for causing a computer to perform a method comprising:
implementing a first communication scheme, comprising:
establishing first data communications, via a first communication device of the computer, with a plurality of individual groups of participating networked end-users, each of the plurality of individual groups comprising a plurality of the participating networked end-users;
masking identifying information for each of the plurality of the participating networked end-users; and
establishing second data communications, via a second separate communication device of the computer, with one or more of data content providers, digital media content providers, and non-participating end-users;
wherein:
the first data communications are established between the first communication device and a plurality of first individual electronic communicating devices, each of the first individual electronic devices being associated with at least one of the plurality of the participating networked end-users; and
the second data communications are established between the second communication device and a plurality of second individual electronic communicating devices, each of the second individual electronic devices being associated with at least one of the one or more of the data content providers, the digital media content providers, and the non participating end-users; and
implementing a second communication scheme, comprising:
separately establishing, via the first communication device of the computer, data content and information exchange among the plurality of the participating networked end-users associated with at least one of the plurality of individual groups of participating networked end-users;
requesting user input from the plurality of the participating networked end-users associated with the at least one of the plurality of individual groups of participating networked end-users, regarding a content of at least one of (1) user rules and (2) user preferences for the data content and information exchange among the plurality of the participating networked end-users associated with the at least one of the plurality of individual groups of participating networked end-users;
receiving the user input from the plurality of the participating networked end-users;
establishing the content of the at least one of (1) the user rules and (2) the user preferences for the data content and information exchange among the plurality of the participating networked end-users associated with the at least one of the plurality of individual groups of participating networked end-users based on the received user input;
requiring acceptance of the established content of the at least one of (1) the user rules and (2) the user preferences for the data content and information exchange prior to data content and information exchange among the plurality of the participating networked end-users associated with the at least one of the plurality of individual groups of participating networked end-users;
facilitating data content and information exchange according to the established content of the at least one of (1) the user rules and (2) the user preferences; and
implementing a plurality of incentives among the plurality of the participating networked end-users associated with the at least one of the plurality of individual groups of participating networked end-users to participate in the data content and information exchange among the plurality of the participating networked end-users associated with the at least one of the plurality of individual groups of participating networked end-users,
wherein:
the individual identifying information for the each of the plurality of the participating networked end-users associated with the at least one of the plurality of individual groups of participating networked end-users is unmasked for the data content and information exchange among the plurality of the participating networked end-users associated with the at least one of the plurality of individual groups of participating networked end-users,
each of the plurality of first individual electronic communicating devices is one of a handheld computing or a handheld communicating device,
the established content of the at least one of (1) the user rules and (2) the user preferences provides limitations regarding access to data content and information exchangeable via the first communication scheme with the second communication device of the computer.

2. The non-transitory computer readable medium of claim 1, wherein the limitations are communicated for separate implementation in the first communication scheme as a gateway to provide content control regarding data content and information accessible from the at least one of the plurality of individual groups of participating networked end-users.

3. The non-transitory computer readable medium of claim 1, wherein the data content and information exchange is organized as one or more channels to which the plurality of the participating networked end-users associated with the at least one of the plurality of individual groups of participating networked end-users have access.

4. The non-transitory computer readable medium of claim 1, wherein the one or more channels are represented as individually selectable icons on a display of the first individual electronic communicating devices of the plurality of the participating networked end-users associated with the at least one of the plurality of individual groups of participating networked end-users.

5. The non-transitory computer readable medium of claim 1, wherein the first communication scheme executes one or more software applications or bots to implement the limitations as content control.

6. The non-transitory computer readable medium of claim 1, wherein the first communication scheme executes one or more application programming interfaces to implement the limitations as content control.

7. The non-transitory computer readable medium of claim 1, wherein the plurality of incentives including additional incentives for engagement the plurality of the participating networked end-users associated with the at least one of the plurality of individual groups of participating networked end-users with the one or more of the data content providers, the digital media content providers and the non-participating individuals accessible via the second communication device of the computer.

8. The non-transitory computer readable medium of claim 1, wherein the plurality of incentives are exchanged as incentive tokens with the one or more of the data content providers, the digital media content providers and the non-participating individuals accessible via the second communication device.

9. The non-transitory computer readable medium of claim 1, wherein the second communication scheme further comprises executing a monitoring routine to (1) monitor the accessible data content and information exchange, and (2) provide suggested updates to the established content of the at least one of the (1) user rules and (2) user preferences, and the plurality of incentives.

10. The non-transitory computer readable medium of claim 1, wherein the second communication scheme further comprises:
requesting additional user input regarding the suggested updates to the established content of the at least one of the (1) user rules and (2) user preferences, and the plurality of incentives;
receiving the additional user input from the plurality of the participating networked end-users;
establishing the new content of the at least one of (1) the user rules and (2) the user preferences for the data content and information exchange among the plurality of the participating networked end-users associated with the at least one of the plurality of individual groups of participating networked end-users based on the received user input; and
requiring acceptance of the established new content.
